(19) United States
(12) Patent Application Publication
(10) Pub. No.: US 2025/0199220 A1
(43) Pub. Date: Jun. 19, 2025

(54) ELECTRONIC DEVICE WITH A COLORED MARKING

(71) Applicant: Apple Inc., Cupertino, CA (US)

(72) Inventors: Michael S. Nashner, San Jose, CA (US); Erica K. Block, Sunnyvale, CA (US); Robert B. Reichenbach, San Francisco, CA (US)

(21) Appl. No.: 18/948,379

(22) Filed: Nov. 14, 2024

Related U.S. Application Data
(60) Provisional application No. 63/611,000, filed on Dec. 15, 2023.

(51) Int. Cl. G02B 5/28

(52) U.S. Cl. CPC G02B 5/285

(57) ABSTRACT

Electronic devices having a colored marking are described. The colored markings described herein may include colored pixels having a color-producing feature, which may be laser-formed. For example, the color of the color-producing feature may be due at least in part to interference of light. In some cases, the colored marking is a multicolor marking that includes pixels having different colors. The colored marking may include an array of the colored pixels and in some cases the colored marking may define an image.

### CROSS-REFERENCE TO RELATED APPLICATION(S)

This application is a nonprovisional application of and claims the benefit of U.S. Provisional Patent Application No. 63/611,000, filed Dec. 15, 2023, and titled “Electronic Device with a Colored Marking,” the disclosure of which is hereby incorporated herein by reference in its entirety.

### FIELD

The described embodiments relate generally to electronic devices and electronic device enclosures having colored markings. More particularly, the present embodiments relate to colored images and other markings formed on an exterior surface of an enclosure for an electronic device.

### BACKGROUND

The housing of some electronic devices may include a marking formed from a paint or an ink. The paint or ink may include a pigment or dye that produces the desired color. However, traditional paint or ink markings may be subject to wear when they are formed on the exterior surface of the housing.

Embodiments described herein are directed to electronic device enclosures with colored markings that may have advantages as compared to electronic device enclosures produced using some traditional marking techniques.

### SUMMARY

Embodiments described herein relate to electronic devices having a colored marking. The colored markings described herein may include colored pixels whose color is due at least in part to interference of light. In some cases, the colored marking is a multicolor marking that includes pixels having different colors. Electronic device enclosures including the colored markings and techniques for forming the colored markings are also described herein.

In some embodiments, the marking includes an array of pixels. The array of pixels may define an image. The colored pixels of the array may have a multilayer structure that is configured to produce a color at least in part through optical interference. As an example, the multilayer structure may include a translucent layer positioned between a reflective base layer and a partially reflective cover layer. In some cases, a base layer may not be required or may not be reflective. The translucent layer may have a thickness that produces interference of light reflected from the base layer and the cover layer. Therefore, this translucent layer is alternately referred to herein as an interference layer. Alternately or additionally, one or more colored pixels of the array may include a color-producing feature other than a multilayer structure that is configured to produce a color at least in part through optical interference. As an example, one or more colored pixels may include a layer that produces color through absorption of light.

In some embodiments, the colored pixels may be formed at least in part using a laser-based technique. In some cases, a laser-based deposition process may be used to deposit one or more layers of a color-producing feature that contributes at least in part to the color of the pixel. For example, a laser-based deposition process may be used to deposit one or more layers of a multilayer structure. Therefore, one or more layers, a multilayer structure, and/or a colored pixel may be referred to as being “laser-formed” or “laser-deposited.” The laser-based deposition process may allow precise control of the positioning and/or one or more dimensions of the layer. For example, a laser-based deposition process may allow deposition of one or more thin layers, so that the colored pixels may not be readily perceptible by touch.

Alternately or additionally, a laser-based technique may be used to prepare a region of the surface of an enclosure component prior to deposition of the pixel layers. For example, the laser-based technique may be used to form a recessed region of the surface, to etch and/or texturize a region of the surface, and/or to modify a region of the surface in order to enhance physical and/or chemical bonding of the marking, thereby improving the durability of the marking.

The techniques described herein may be used to form a colored marking that has sufficient wear resistance to be used at an exterior surface of an electronic device. In some examples, the colored marking may be formed within a shallow recess formed at the exterior surface. Alternately or additionally, the region of the exterior surface on which the multicolor marking is to be formed may be treated to improve adhesion of the multicolor marking to the exterior surface. In some cases, a protective coating, such as a transparent cover layer, may be formed over the multicolor marking in order to provide further protection to the marking.

The disclosure provides an electronic device comprising a battery, electronic circuitry operably coupled to the battery and comprising a processor, wireless communication circuitry operably coupled to the battery, and an enclosure enclosing the battery, electronic circuitry, and the wireless communication circuitry, the enclosure comprising a housing member formed from a polymer material and defining an exterior surface of the electronic device; and an image formed at the exterior surface and comprising a plurality of pixels, the plurality of pixels including a first pixel configured to produce a first color, the first pixel comprising a first interference layer formed from a metal oxide, disposed over the exterior surface, and having a first thickness, and a first cover layer formed from a metal, disposed over the first interference layer, and configured to partially reflect visible light, and a second pixel configured to produce a second color, different from the first color, the second pixel comprising a second interference layer formed from the metal oxide, disposed over the exterior surface, and having a second thickness different from the first thickness, and a second cover layer formed from the metal, disposed over the second interference layer, and configured to partially reflect visible light.

The disclosure also provides an electronic device comprising an enclosure comprising a housing member defining an exterior surface of the electronic device and a multicolored marking comprising an array of pixels, the array of pixels including a plurality of first pixels, each of the first pixels having a first multilayer structure that produces a first color and comprising a first reflective layer disposed over a first portion of the exterior surface, a first translucent layer disposed over the first reflective layer, and a first partially reflective layer disposed over the first translucent layer, and a plurality of second pixels, each of the second pixels having a second multilayer structure configured to produce a second color, different from the first color, the second multilayer structure comprising a second reflective layer disposed over a second portion of the exterior surface, a second translucent layer disposed over the second reflective layer, and a second partially reflective layer disposed over the second translucent layer, and a battery positioned within the enclosure.

The disclosure also provides an electronic device comprising an enclosure comprising a housing member defining an exterior surface of the electronic device and a multicolored marking disposed over a surface of the housing and comprising an array of pixels, the array of pixels including a plurality of first pixels, each of the first pixels having a first color and comprising a first laser-deposited layer that contributes to the first color, and a plurality of second pixels, each of the second pixels having a second color, different from the first color; and comprising a second laser-deposited layer, different from the first laser-deposited layer, that contributes to the second color and a battery positioned within the enclosure.

The disclosure also provides an electronic device comprising an enclosure comprising a polymer housing member defining an exterior surface of the electronic device and an image formed at a region of the exterior surface and comprising a first subpixel having a first color due to a first optical interference, the first subpixel comprising a first reflective base layer disposed over the region of the exterior surface, a first translucent layer disposed over the first reflective base layer, and a first partially reflective cover layer disposed over the first translucent layer, and a second subpixel having a second color, different from the first color, due to a second optical interference, the second subpixel comprising a second reflective base layer disposed over the region of the exterior surface, a second translucent layer disposed over the second reflective base layer, and a second partially reflective cover layer disposed over the second translucent layer, a battery positioned within the enclosure, and electronic circuitry positioned within the enclosure and coupled to the battery.

### BRIEF DESCRIPTION OF THE DRAWINGS

The disclosure will be readily understood by the following detailed description in conjunction with the accompanying drawings, wherein like reference numerals designate like elements.

FIG. 1 shows an example device including a colored marking.

FIG. 2A shows an example of a cross-sectional view through a colored marking.

FIG. 2B shows another example of a cross-sectional view through a colored marking.

FIG. 3 shows an enlarged view of the interface between a colored marking and a housing component.

FIG. 4 shows an example of a top view of an array of pixels in a portion of a colored marking.

FIG. 5 shows an example of a partial cross-sectional view of pixels of a colored marking.

FIG. 6 shows another example of a partial cross-sectional view of pixels of a colored marking.

FIG. 7 shows another example of a partial cross-sectional view of pixels of a colored marking.

FIG. 8 shows another example of a partial cross-sectional view of pixels of a colored marking.

FIG. 9 shows another example of a partial cross-sectional view of pixels of a colored marking.

FIG. 10 shows another example of a top view of an array of pixels in a portion of a colored marking.

FIG. 11 shows another example of a partial cross-sectional view of pixels of a colored marking.

FIG. 12A shows another example of a top view of an array of pixels in a portion of a colored marking.

FIG. 12B shows an example of a partial cross-sectional view of pixels from the colored marking of FIG. 12A.

FIG. 13A shows an example of a top view of a set of subpixels in a portion of a colored marking.

FIG. 13B shows an example of a partial cross-sectional view of subpixels from FIG. 13A.

FIG. 14 shows another example of a partial cross-sectional view of pixels of a colored marking.

FIGS. 15A, 15B, and 15C show another example of an electronic device including a colored marking.

FIG. 16 shows a block diagram of components of an electronic device.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments illustrated in the accompanying drawings. It should be understood that the following descriptions are not intended to limit the embodiments to one preferred implementation. To the contrary, the described embodiments are intended to cover alternatives, modifications, and equivalents as can be included within the spirit and scope of the disclosure and as defined by the appended claims.

Embodiments described herein relate to electronic devices having a colored marking. The colored markings described herein may include colored pixels whose color is due at least in part to interference of light. In some cases, the colored marking is a multicolor marking that includes pixels having different colors. Electronic device enclosures including the colored markings and techniques for forming the colored markings are also described herein.

In some embodiments, the marking includes an array of pixels. The array of pixels may define an image. In some examples, one or more colored pixels of the array may have a multilayer structure that is configured to produce a color at least in part through optical interference. As an example, the multilayer structure may include a translucent layer positioned between a reflective base layer and a partially reflective cover layer. In some cases, a base layer may not be required or may not be reflective. The translucent layer may have a thickness that contributes to the color of the pixel, e.g., by influencing interference of light reflected from the base layer and the cover layer. Therefore, this translucent layer is alternately referred to herein as an interference layer. Alternately or additionally, one or more colored pixels of the array may include a color-producing feature other than a multilayer structure that is configured to produce a color at least in part through optical interference, as discussed in more detail below. As an example, one or more colored pixels may include a layer that produces color through absorption and/or reflection of light.

In some embodiments, the colored pixels may be formed at least in part using a laser-based technique. In some cases, a laser-based deposition process may be used to deposit one or more layers of a color-producing feature that contributes at least in part to the color of the pixel. For example, a laser-based deposition process may be used to deposit one or more layers of a multilayer structure. Therefore, one or more layers, a multilayer structure, and/or a colored pixel may be referred to as being “laser-formed” or “laser-deposited.” The laser-based deposition process may allow precise control of the positioning and/or one or more dimensions of the layer. For example, a laser-based deposition process may allow deposition of one or more thin layers, so that the colored pixels may not be readily perceptible by touch. In some cases, laser induced forward transfer or another laser-based deposition technique may be used to deposit one or more of the layers. Alternately or additionally, a laser-based process may be used to control the thickness of or remove one or more of the layers. For example, the laser-based removal process may be a laser ablation process. In some cases, a laser-based process may be used to modify a chemical and/or a physical property of a layer, such as by sintering, curing, annealing, or the like.

Alternately or additionally, a laser-based technique may be used to prepare a region of the surface of an enclosure component prior to deposition of the pixel layers. For example, the laser-based technique may be used to form a recessed region of the surface, to etch and/or texturize a region of the surface, and/or to modify a region of the surface in order to enhance physical and/or chemical bonding of the marking, thereby improving the durability of the marking.

The techniques described herein may be used to form a colored marking that has sufficient wear resistance to be used at an exterior surface of an electronic device. In some embodiments, the heat contributed by the laser enhances bonding of a laser-formed layer deposited on the housing member. In some examples, the colored marking may be formed within a shallow recess formed at the exterior surface. Alternately or additionally, the region of the exterior surface on which the multicolor marking is to be formed may be treated to improve adhesion of the multicolor marking to the exterior surface. In some cases, a protective coating may be formed over individual pixels of the multicolor marking or over the marking as a whole in order to provide further protection to the marking. For example, the protective coating may be a transparent cover layer.

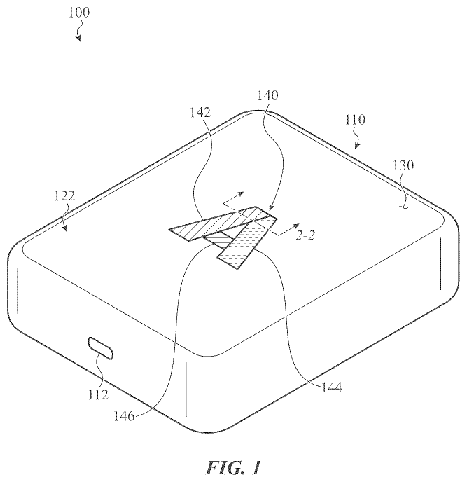

These and other embodiments are discussed below with reference to FIGS. 1-16. However, those skilled in the art will readily appreciate that the detailed description given herein with respect to these figures is for explanatory purposes only and should not be construed as limiting.

FIG. 1 shows a simplified example of an electronic device including a colored marking. In the example of FIG. 1, the electronic device 100 includes an enclosure 110 that includes a housing component 122. The housing component 122 may be formed of a single housing member or may be formed of multiple housing members.

A colored marking 140 is formed on a surface 130 of the housing component 122. The colored marking 140 may be formed on any suitable surface of the enclosure 110, including a curved surface of the enclosure. In some examples, the surface 130 may define an external surface of the electronic device, such as a front surface, a rear surface, a side surface, a top surface, or a bottom surface of the electronic device.

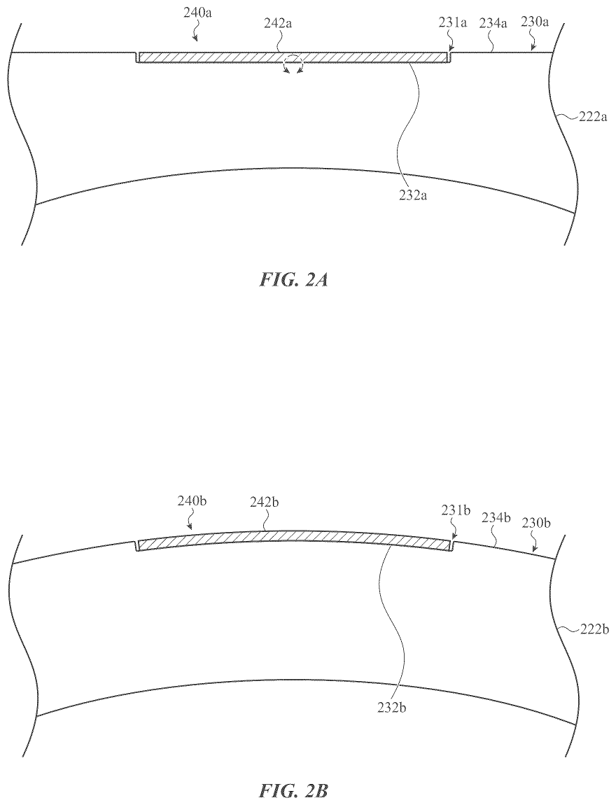

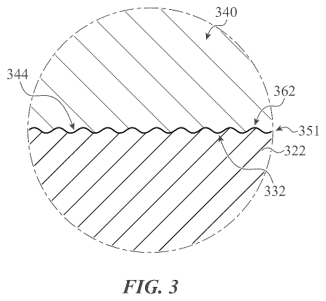

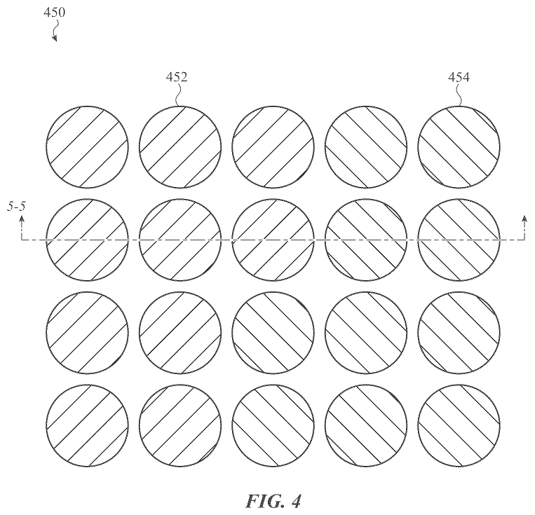

The colored marking 140 may be formed along a first region of the surface 130, also referred to herein as a marking region. A second region of the surface 130 may surround the marking region and may therefore be referred to herein as a frame region. In some cases, the marking region may have a different elevation and/or texture than the frame region as is discussed in more detail with respect to FIGS. 2A, 2B and 3.

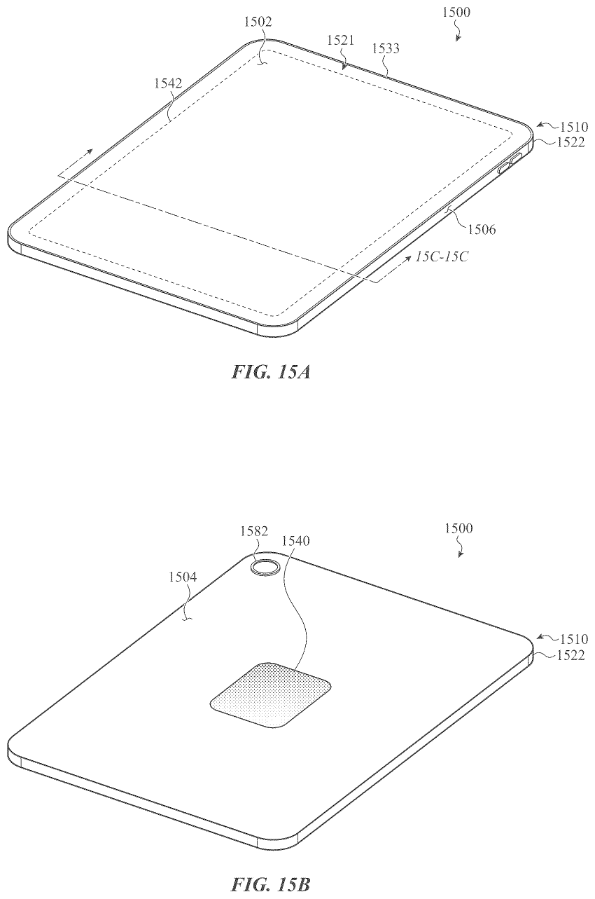

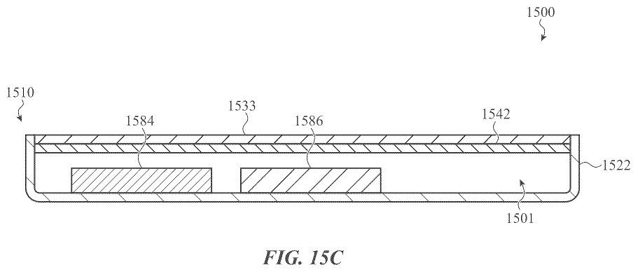

The electronic device 100 (also referred to simply as a device) may be a portable electronic device or other suitable electronic device. In some embodiments, the electronic device 100 may be a tablet computing device (e.g., a tablet), as shown in the examples of FIGS. 15A through 15C. In other embodiments, the electronic device 100 may be a mobile telephone, a notebook computing device (e.g., a notebook), a portable media player, a wearable device, or another type of portable electronic device. As additional examples, the portable electronic device may be an electronic watch, such as a smart watch, a camera, a headphone device, a headphone enclosure, an earpiece device, an earpiece enclosure, a remote control, an identifier (e.g., a card), a computer component, an input device, a charging device, a protective case, or virtually any other type of electronic product or device component.

In the example of FIG. 1, the colored marking 140 includes three portions, the portions 142, 144, and 146. In some examples, the portions 142, 144, and 146 have different colors. The colored marking 140 generally includes a plurality of localized elements, which are referred to herein as pixels. In some cases, the colored marking 140 includes an array of pixels. In some embodiments, the colored marking 140 is a multicolored marking that includes pixels of two or more colors. The colored marking 140 of FIG. 1 has been simplified for purposes of illustration but this example is not limiting and in additional examples the colored markings described herein may be more complex, as illustrated by the marking 1540 of FIG. 15B and described below.

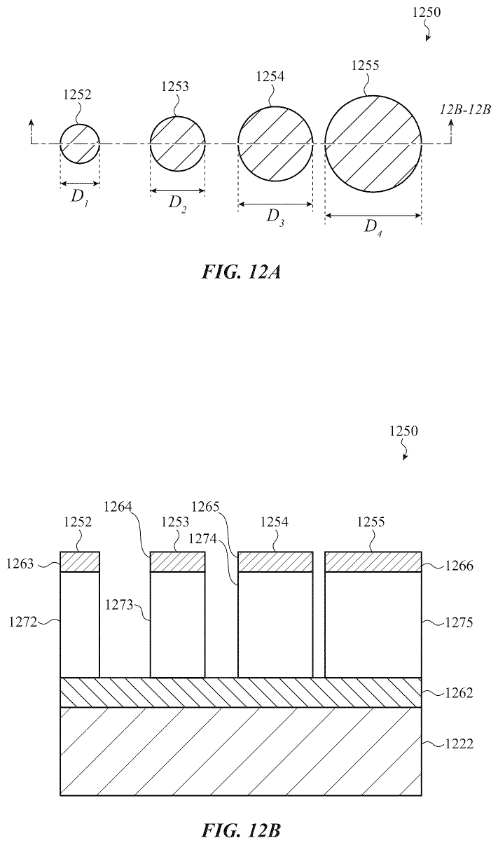

In embodiments, the colored marking 140 defines one or more of an image, a letter, a number, a serial identification, a 1D bar code, a 2D bar code, or other encoded information regions. The image may be a digital image. The digital image may represent a logo, a photographic image, a drawing, and the like. In some cases, the digital image may represent a non-digital image. The marking may have a particular resolution, such as a minimum spacing between pixels. In some examples, when viewed at a typical viewing distance (e.g., greater than about 15 cm or greater than about 30 cm) the individual pixels of the marking may be difficult or impossible to distinguish with the unaided eye. When individual pixels of the marking are defined by a group of subpixels, the individual subpixels may be difficult or impossible to distinguish with the unaided eye. Suitable spacings between the pixels are discussed at least with respect to FIGS. 4 and 12A and that discussion is not repeated here.

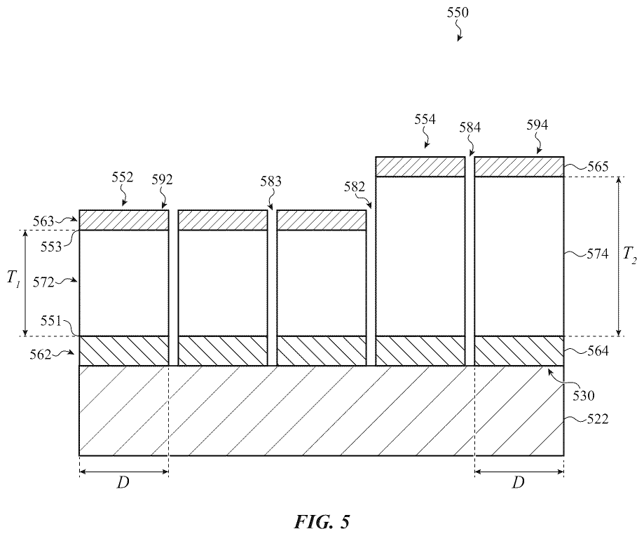

In embodiments described herein, at least some of the pixels have a multilayer structure that produces a color at least in part through optical interference. Therefore, these pixels need not include a pigment or dye to produce a color. The optical interference may produce a reflectance spectrum that has one or more peaks, and the peak(s) of the reflectance spectrum may determine the perceived color of the pixel. The reflectance spectrum may be influenced by constructive and/or destructive interference of light, as discussed in more detail below. In some examples, at least some of the pixels have a multilayer structure that includes a layer that produces a color by a process other than optical interference and another layer such as a base layer or a cover layer. Examples of multilayer structures are shown in FIGS. 5-9, 11, 12B, and 13B.

Interaction of light with layers of the multilayer structure may contribute to the optical interference and the color of the pixel. For example, the multilayer structure may include a translucent layer positioned above a reflective layer and below a partially reflective layer. Light incident on the partially reflective layer may be partially externally reflected from the partially reflective layer and partially transmitted through the partially reflective layer into the translucent layer. Light transmitted through the translucent layer may be reflected from the reflective layer and transmitted back through the translucent layer towards the partially reflective layer. When this light reaches the partially reflective layer, some of the light may be transmitted through the partially reflective layer and some of the light may be reflected back into the translucent layer. Therefore, multiple internal reflections of light within the translucent layer may occur. As another example, a reflective base layer need not be included in the multilayer structure.

The translucent layer may have a thickness configured to produce a color at least in part through interference of light. For example, the thickness of the translucent layer may influence the optical path length difference(s) and thus the phase difference(s) between rays of light traveling different paths. In some cases, the optical path length difference may be a multiple of a wavelength (e.g., the multiplier may be an integer m or m+½). The optical path length is also influenced by the refractive index of the translucent layer. Therefore, different colors may be produced by pixels having different translucent layer thicknesses and/or refractive indices. As mentioned above, one or more layers of the multilayer structure may be deposited using a laser-based process to control the positioning and/or one or more dimensions of the layer. Multilayer structures are described in more detail at least with respect to FIGS. 5-9, 11, 12B, and 13B and that description is generally applicable herein and not repeated here.

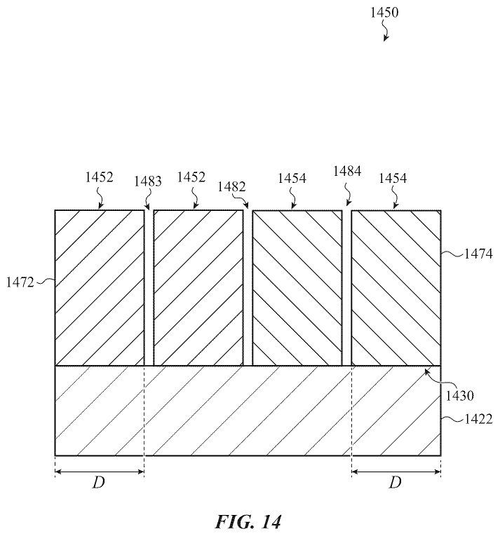

Alternately or additionally, one or more colored pixels of the array may include a color-producing feature other than a multilayer structure that is configured to produce a color at least in part through optical interference. Examples of color-producing features other than multilayer structures configured to produce optical interference include, but are not limited to, a polymeric film, a metallic film, a metal oxide film, and the like that contribute to the color of the pixel. Such a color-producing feature may be a laser-deposited layer, as previously discussed. The additional description of these color-producing features provided with respect to FIG. 14 is generally applicable herein and is not repeated here.

A housing component or member may be formed of a polymer material, a metal material, a glass material, a ceramic material, or the like. In some embodiments, the housing component or member is formed of a polymer material. The polymer material may include a polymer and a pigment or dye disposed in the polymer. In some embodiments, the polymer material may include the polymer and an additional filler material such as reinforcing fibers or particles. The polymer may comprise one or more of polycarbonate (PC), acrylonitrile butadiene styrene (ABS), and the like. The pigment may be a metal oxide pigment such as a titanium oxide (e.g., titanium dioxide). A metal housing component or member may be formed from a metal or alloy such as an aluminum alloy, steel, a magnesium alloy, a titanium alloy, or combinations thereof.

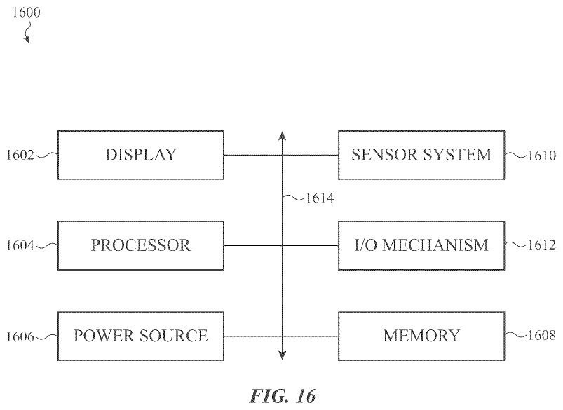

In the example of FIG. 1, the enclosure 110 defines an opening 112. In some cases, the opening 112 may provide a port for charging the electronic device. In additional examples, the housing may define one or more openings for internal components that receive input and/or produce output. In aspects of the disclosure, the electronic device 100 includes one or more electronic components. In some cases, the electronic device may include one or more of a battery, electronic circuitry (e.g., control circuitry, wireless communication circuitry), a processor, a sensor, a display, and memory. More generally, the electronic components may be any of those discussed with respect to FIG. 16 and that description is not repeated here. The housing 100 may define an interior volume configured to receive one or more of the electronic components as shown in the simplified cross-sectional view of FIG. 15C.

FIGS. 2A and 2B show examples of cross-sectional views of a colored marking. As shown in FIGS. 2A and 2B, the colored marking is positioned at least partially within a recess, which can help to protect the colored marking from wear. Each of the colored marking 240a of FIG. 2A and the colored marking 240b of FIG. 2B may be an example of the colored marking 140 of FIG. 1, with the cross-section taken along line 2-2 of FIG. 1. The examples of FIGS. 2A and 2B are not intended to be limiting and in other embodiments the colored marking need not be positioned within a recess.

In the example of FIG. 2A, the housing component 222a defines a recess 231a along the surface 230a of the housing component 222a. The recess 231a defines a recessed region 232a of the surface 230a and the colored marking 240a is formed at the recessed region 232a. The recessed region 232a is substantially planar, however this example is not limiting, and the recessed region may be curved as illustrated by the recessed region 232b of FIG. 2B and/or textured as shown in FIG. 3. A top surface 242a of the colored marking 240a is substantially flush with respect to a surrounding region 234a of the surface 230a. The recessed region 232a may define a marking region and the surrounding region 234a may define a frame region as previously discussed with respect to FIG. 1. However, this example is not limiting and in other examples the top surface 242a of the colored marking 240a may be proud of or recessed with respect to the surface 230a.

FIG. 2B shows another example of a cross-sectional view of a colored marking. In the example of FIG. 2B, the surface 230b of the housing component 222b includes a curved recessed region 232b and a curved surrounding region 234b. The top surface 242b of the colored marking 240b is also curved. However, the housing component 222b and the colored marking 240b may be similar in other respects to the housing component 222a and the colored marking 240a. As previously discussed with respect to FIG. 1, when the housing component includes multiple members, the colored marking may be formed on one of the housing members.

The recesses, such as the recesses 231a and 231b, may be formed using a laser-based technique. For example, the recesses 231a and 231b may be formed by ablating material from the housing components 222a and 222b. In some examples, the recesses can be formed without discoloring the surrounding material of the housing component. Any laser wavelength, average power, and pulse duration suitable for use with the material of the housing component may be used to form the recess. In some embodiment, the laser produces pulses having a femtosecond or a picosecond duration. A laser-based technique may also be used to impart a desired surface texture to the surfaces of the recessed regions 232a and 232b, as described in more detail with respect to FIG. 3. When the surface 230b is curved, the laser-based technique may use three-dimensional optics.

FIG. 3 shows an enlarged view of the interface between a colored marking and a housing component. In the example of FIG. 3, the surface region 332 of the housing component 322 defines a surface texture including surface features 362. As a result, the interface 351 also defines a surface texture. In some cases, the surface texture can help improve adhesion between the colored marking 340 and the housing component 322. For example, the surface texture can contribute to mechanical interlocking of bottom surface 344 of the colored marking 340 with the surface region 332 of the housing component 322. In some cases, an average height of the surface features (e.g., Ra or Sa) is greater than 10 nm and less than the thickness of one or more layers of the colored marking (e.g., the layers 562 and/or 572 of FIG. 5). As previously discussed with respect to FIG. 1, when the housing component includes multiple members, the colored marking may be placed on one of the housing members. As previously discussed, a region of the exterior surface that surrounds the surface region 332 may have a texture that is different than the texture of the surface region 332. For example, a second texture of the surrounding region of the exterior surface may have a texture that is smoother than a first texture of the surface region 332.

In some embodiments, a laser-based process may be used to form the surface texture. In some cases, the laser-based process may form laser-induced periodic surface structure. By way of example, the laser used to form the surface texture may produce a wavelength in the visible range (e.g., a green wavelength) and the pulse duration may be from about 200 fs to about 800 fs.

FIG. 4 shows an example of a top view of an array of pixels in a portion of a colored marking. The array 450 includes pixels 452 having a first color and pixels 454 having a second color. The view of FIG. 4 may be an example of a view along 2-2 of FIG. 1 at the boundary between the portions 142 and 144 of the marking 140. The hatching patterns shown in FIG. 4 are not intended to limit the pixels to specific colors. Instead, the different hatching patterns are intended to clearly illustrate differences between the pixel colors. The pixel colors may be chromatic colors having a distinct hue rather than an achromatic color.

The color may be measured in several ways. In some cases, the color of individual pixels may be measured directly. However, when individual subpixels or pixels are small, it may be simpler to measure the color of a group of pixels. In some embodiments, color may be characterized by a coordinate in CIEL*a*b* (CIELAB) color space. In CIEL*a*b* (CIELAB) color space, L* represents lightness (or brightness), a* the position between red/magenta and green, and b* the position between yellow and blue. Alternately or additionally, color may be characterized by coordinates in L*C*h* color space, where C* represents the chroma and h* represents the hue angle (in degrees). The chroma C* is related to a* and b* as C*=\sqrt{(a*)²+ (b*)²}. In addition, the hue angle h_{ab} is related to a* and b* as

$${h}_{a b} = {tan}^{- 1} \frac{{b}^{*}}{{a}^{*}} .$$

The symbol h* as used herein may refer to h_{ab}. The color coordinates for a given illuminant can be measured with a device such as a colorimeter or a spectrophotometer using standard measurement techniques.

In some embodiments, the difference in pixel color may be described by a difference in hue angle. In some embodiments, the hue difference (ΔH*) between the first pixels 452 and the second pixels 454 may be greater than 20 degrees and less than 360 degrees, greater than 45 degrees and less than 360 degrees, greater than or equal to 90 degrees and less than 360 degrees, greater than or equal to 180 degrees and less than 360 degrees, or greater than or equal to 270 degrees and less than 360 degrees. When the pixel color is measured for a group of pixels, the differences in color between a group of first pixels and a group of second pixels may have a similar hue difference between the two groups of pixels.

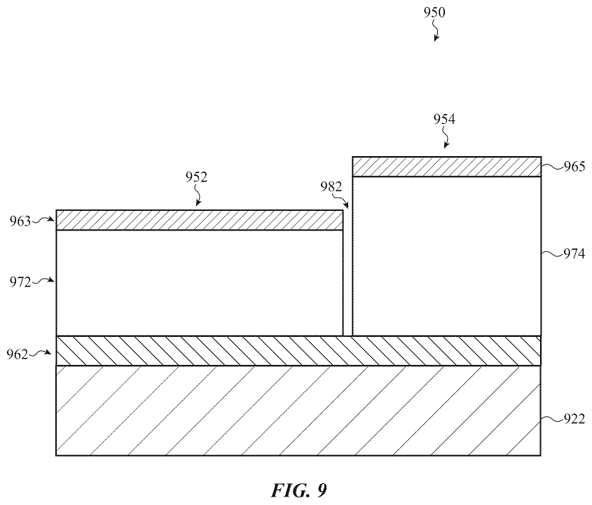

As shown in the top view of FIG. 4, the pixels 452 and 454 define a generally circular outline. In embodiments, the pixels may define an outline that is circular, elliptical, rectangular, square, other suitable shapes, or combinations thereof. In some embodiments, the pixels may have a lateral dimension, such as a diameter, ranging from 5 micrometers to 20 micrometers, from 2 micrometers to 10 micrometers, or from 10 micrometers to 50 micrometers. When the pixels are formed using a laser-based process, the spot size of the laser, individually or in combination with other laser parameters, may be used to control the diameter of the pixels. The pixels may have a substantially uniform diameter, or the diameter of the pixels may vary as shown in the examples of FIGS. 12A and 12B. When the pixels are distributed on a grid, the spacing between the gridlines (e.g., the center-to-center spacing of the pixels) may be greater than or equal to the lateral dimension of the pixels. In other examples neighboring pixels of the same color may adjoin each other as shown in the example of FIG. 9, may overlap each other, or may have an irregular arrangement.

FIG. 5 shows an example of a partial cross-sectional view of pixels of a colored marking. The array 550 of pixels includes first pixels 552 having a first color and second pixels 554 having a second color that is different from the first color. The view of FIG. 5 may be an example of a view along line 5-5 of the array 450 of FIG. 4. The array 550 of pixels is formed on a housing component 522, which may be similar to the housing component 122.

In the example of FIG. 5, each of the first pixels 552 and the second pixels 554 includes a multilayer structure that may produce a color at least in part through interference as described in more detail below. Therefore, the first pixels 552 and the second pixels 554 need not include a dye or pigment to produce their color. In some embodiments, the first pixels 552 and the second pixels 554 may be substantially free of a coloring agent such as a dye or pigment. Interaction of light with layers of the multilayer structure may contribute to the optical interference and the color of the pixel. In the example of FIG. 5, each multilayer structure includes a reflective layer (e.g., 562), a translucent layer (e.g., 572) disposed over the reflective layer, and a partially reflective layer (e.g., 563) disposed over the translucent layer. Additional description of these pixel layers and their contribution to the color of the pixel is provided below.

The first pixel 552 includes a first partially reflective layer 563. The first partially reflective layer 563 forms the upper layer of the multilayer structure and is alternately referred to herein as a first cover layer. The first partially reflective layer 563 may be configured to externally reflect some of the light incident on the first pixel 552 and to transmit some of the incident light into the translucent layer 572. The first partially reflective layer 563 may be formed of a metal, including, but not limited to, silver, aluminum, gold, and alloys thereof, and may have a thickness that allows transmission of some of the incident light. The thickness of the first partially reflective layer 563 is exaggerated in FIG. 5 for convenience of illustration and is typically on the order of several nanometers. In some cases, the first partially reflective layer 563 may absorb some wavelengths of visible light, with this absorption also influencing the color of the pixel.

The first pixel 552 also includes a first translucent layer 572. The first translucent layer 572 allows light passing through the first partially reflective layer 563 to be transmitted to the first reflective layer 562 and also allows light reflected from the first reflective layer 562 to be transmitted back towards the first partially reflective layer 563. The first thickness T₁ of the first translucent layer 572 influences interference of light therefore the first translucent layer 572 may alternately be referred to herein as a first interference layer. The thickness T₁ may be less than one micrometer. The first translucent layer may be transparent, allowing at least 70%, 80%, or 90% transmission of light across the visible spectrum. The first translucent layer 572 may be formed of a first translucent material. The first translucent material may be a dielectric material, which may be an inorganic dielectric material or an organic dielectric material. In some cases, the dielectric material has an index of refraction of at least 1.5. In some cases, the dielectric material may be a metal oxide such as a titanium oxide or a silicon oxide. In other cases, the dielectric material may be a polymer material.

The first pixel 552 also includes the first reflective layer 562. The first reflective layer 562 forms the lower layer of the first multilayer structure 592 and therefore is alternately referred to as a first base layer. The first reflective layer 562 may be disposed over the surface 530 of the housing component. The first reflective layer 562 may be formed of a metal, including, but not limited to, silver, aluminum, gold, and alloys thereof. The first reflective layer 562 may be formed of a same metal as the first partially reflective layer 563 or may be formed of a different metal. The first reflective layer 562 may be substantially opaque, so that no light is transmitted through this layer. The thickness of the first reflective layer may be greater than the thickness of the first partially reflective layer and less than one micrometer.

Light incident on the partially reflective layer 563 may be partially externally reflected from the partially reflective layer and partially transmitted through the partially reflective layer 563 into the translucent layer 572. Light transmitted through the translucent layer 572 may be reflected from the reflective layer 562 and transmitted back through the translucent layer 572 towards the partially reflective layer 563. When this light reaches the partially reflective layer 563, some of the light may be transmitted through the partially reflective layer 563 and some of the light may be reflected back into the translucent layer 572. Therefore, multiple internal reflections of light within the translucent layer 572 may occur.

In embodiments, the first multilayer structure 592 produces the first color at least in part through a first optical interference. The first multilayer structure 592 may influence interference of light in several ways. Without wishing to be bound by any particular belief, reflection of light from and transmission of light through various layers and interfaces of the multilayer structure may influence interference of light. The reflection of light includes reflection of light from the first partially reflective layer 563 (external reflection from the exterior surface, internal reflection at the interface 553 with the translucent layer 572, or both) and reflection of light from the interface 551 between the first reflective layer 562 and the translucent layer 572. The transmission of light includes transmission of light through the first partially reflective layer 563 into the translucent layer 572 and transmission of light out of the translucent layer 572 and through the first partially reflective layer 563. As previously discussed, the thickness of the first translucent layer 572 and the dielectric constant of the first translucent layer 572 may also influence the first optical interference. The description of factors that may contribute to optical interference provided with respect to the first pixel 552 is generally applicable herein.

The second pixel 554 has a second color. In embodiments, the second multilayer structure 594 of the second pixel 554 produces the second color at least in part through a second optical interference. The second multilayer structure 594 includes a second partially reflective layer 565, a second translucent layer 574, and a second reflective layer 564 (alternately referred to as a second base layer). The second translucent layer 574 may be formed of a second translucent material. In some cases, the second translucent layer 574 has substantially the same material composition as the first translucent layer 572, so that the difference in color is due to a factor other than a difference in material composition. In the example of FIG. 5, the second translucent layer 574 has a second thickness T₂ that is different than the first thickness T₁. The difference between the first thickness T₁ and the second thickness T₂ may therefore contribute to the difference between the second color and the first color (e.g., when the first and second translucent layers 572 and 574 are formed of a same material), as previously described. In the example of FIG. 5, the thickness T₂ is greater than the thickness T₁. When the translucent layers are deposited using a laser-based process, the greater thickness may be achieved by modifying the laser pulsed parameters and/or by using a greater number of deposition operations. When multiple deposition operations are used, the translucent layer may be formed of multiple sublayers.

The second partially reflective layer 565, the second translucent layer 574, and the second reflective layer 564 may have similar properties and may be formed of similar materials as the first partially reflective layer 563, the first translucent layer 572, and the first reflective layer 562. However, in some cases, one or more layers of the second pixel 554 may be formed from a different material than the corresponding layer of the first pixel (e.g., the partially reflective layers and/or the translucent layers of the first and the second pixels may differ in composition).

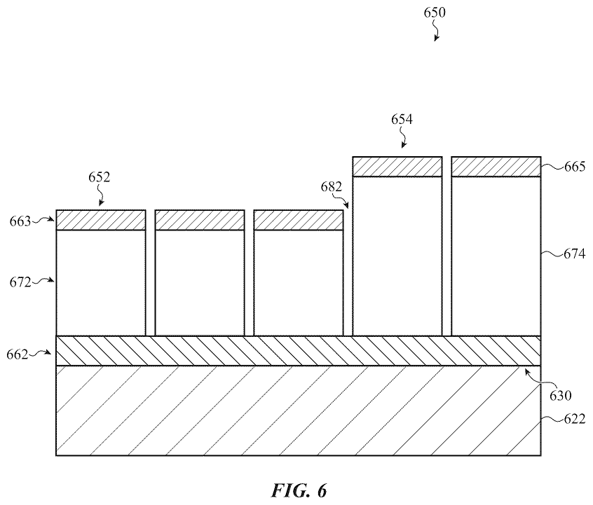

In the example of FIG. 5, the array 550 defines a gap 582 between neighboring first and second pixels 552 and 554. In the example of FIG. 5, the first pixel 552 and the second pixel 554 are adjacent to each other. In this example, the gap 582 extends between the first and second translucent layers 572 and 574 and the first and second reflective layers 562 and 564. The gap 582 also extends between the first partially reflective layer 563 and the second translucent layer 574. However, this example is not limiting and in other examples the gap need not extend between the first and second reflective layers, as shown in the examples of FIGS. 6-9. In some examples, the gap 582 may extend between the first and second partially reflective layers 563 and 565 or between other partially reflective layers and translucent layers depending upon the relative thicknesses of the translucent layers. The array 550 also defines a gap 583 between neighboring first pixels 552 and a gap 584 between neighboring second pixels 554. However, this example is not limiting and in other examples neighboring pixels of the same color may adjoin each other as shown in the example of FIG. 9 or overlap. The size of the gaps between pixels shown in FIG. 5 are not limiting and may vary as shown in the example of FIGS. 12A and 12B. When the pixels have a generally circular outline in a top view, the size of any gaps between pixels may depend on the plane of the cross-section.

In the example of FIG. 5, the first and second pixels 552 and 554 have a lateral dimension, such as the diameter D, which is substantially the same. The examples of pixel diameters provided with respect to FIG. 4 are generally applicable herein. However, this example is not limiting and in other examples the pixels may have different lateral dimensions, as shown in the example of FIGS. 12A and 12B.

In some cases, one or more layers of a pixel may be deposited using a laser to control the positioning and one or more dimensions of the layer. Therefore, a pixel may include one or more laser-deposited layers. For example, laser induced forward transfer (LIFT) or another laser-based deposition process may be used to deposit a layer of the pixel. For a multilayer structure including a partially reflective layer, a translucent layer, and a reflective layer, one or more of these layers may be a laser-deposited layer. As a specific example, the different thicknesses of the translucent layer may be obtained by using several deposition operations to deposit thicker translucent layers or by varying characteristics of the laser pulse during a single deposition operation in order to vary the amount of material deposited. Alternately or additionally, a laser may be used to modify one or more layers after it is deposited, such as by annealing, sintering, and/or removing material to smooth the edges or modify the thickness and/or lateral dimension of a layer.

In some embodiments, heat contributed by the laser enhances bonding of a laser-formed layer to an underlying housing member or underlying layer. For example, the heat contributed by the laser may enhance bonding of a metallic reflective layer or a polymeric layer deposited on a housing member. However, the amount of heat contributed by the laser may be limited so as to avoid undesirable modification of the housing member, the metallic reflective layer or polymeric layer, and/or the carrier from which the metallic reflective layer or polymeric layer are transferred. The amount of heat contributed by the laser may be limited at least in part by controlling the laser energy.

FIG. 6 shows another example of a partial cross-sectional view of pixels of a colored marking. The array 650 of pixels includes first pixels 652 having a first color and second pixels 654 having a second color that is different from the first color. The view of FIG. 6 may be an example of a view along the line 5-5 of the array 450 of FIG. 4. The array 650 of pixels is formed on a housing component 622, which may be similar to the housing component 122.

In contrast to the example of FIG. 5, the array 650 includes a reflective layer 662 that is a continuous layer and that defines a base layer of the first pixels 652 and the second pixels 654. Therefore, the base layer of each of the pixels 652 and 654 may be a respective portion of the reflective layer 662. Because the reflective layer 662 is continuous, the gap 682 between a neighboring first pixel 652 and second pixel 654 extends only between the first and second translucent layers 672 and 674, respectively. The reflective layer 662 may be disposed over the surface 630 of the housing component. The reflective layer 662 may have similar properties and may be formed of similar materials as the first reflective layer 562.

The first pixels 652 further include a first translucent layer 672 and a first partially reflective layer 663. The second pixels 654 further include a second translucent layer 674 and a second partially reflective layer 665. The first partially reflective layer 663 and the first translucent layer 672 may have similar properties and may be formed of similar materials as the first partially reflective layer 563 and the first translucent layer 572. The second partially reflective layer 665 and the second translucent layer 674 may have similar properties and may be formed of similar materials as the second partially reflective layer 565 and the second translucent layer 574.

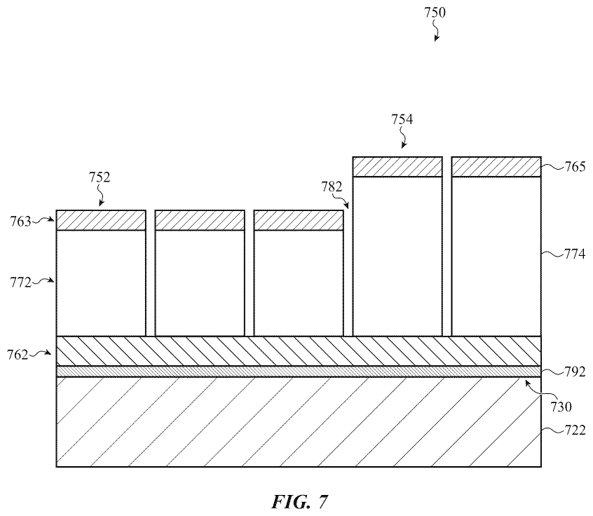

FIG. 7 shows another example of a partial cross-sectional view of pixels of a colored marking. The array 750 of pixels includes first pixels 752 having a first color and second pixels 754 having a second color that is different from the first color. The view of FIG. 7 may be an example of a view along the line 5-5 of the array 450 of FIG. 4. The housing component 722 may be similar to the housing component 122.

In contrast to the example of FIG. 6, an adhesion layer 792 is provided along the surface 730 of the housing component 722, between the housing component and the reflective layer 762. Examples of adhesion layers include, but are not limited to, layers including functional groups that enhance bonding of the layer to the housing component and/or the base layer of the multilayer structure. In some cases, the adhesion layer may be formed from a polymer adhesive material.

The first pixels 752 include a respective portion of the reflective layer 762, a first translucent layer 772, and a first partially reflective layer 763. The second pixels 754 include a respective portion of the reflective layer 762, a second translucent layer 774, and a second partially reflective layer 765. The first pixels 752 and the second pixels 754 may have similar properties and the pixel layers may be formed of similar materials as the first pixels 652 and the second pixels 654. A gap 782 is present between a neighboring first pixel 752 and second pixel 754. The example of FIG. 7 is not limiting, and an adhesion layer may be used with other arrangements of pixels described herein.

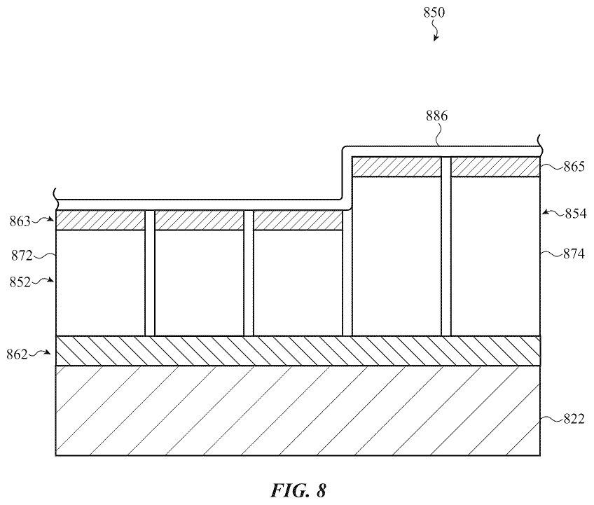

FIG. 8 shows another example of a partial cross-sectional view of pixels of a colored marking. The array 850 of pixels includes first pixels 852 having a first color and second pixels 854 having a second color that is different from the first color. The view of FIG. 8 may be an example of a view along the line 5-5 of the array 450 of FIG. 4. The housing component 822 may be similar to the housing component 122.

In contrast to the examples of FIGS. 5-7, a top layer 886 is provided over the first pixels 852 and the second pixels 854. The top layer 886 may help to protect the array 850 from wear. The top layer 886 may alternately be referred to herein as a cover layer. The top layer 886 may be translucent (e.g., a transparent layer). The top layer 886 may be formed from translucent oxide material (e.g., a silicon or metal oxide) or a translucent polymer material (e.g., a polymer “hardcoat”). In the example of FIG. 8, the top layer 886 need not extend into gaps between the pixels. However, in other embodiments the top layer may conformally coat the pixels and extend into gaps between pixels or may be present as a top layer over individual pixels (e.g., as a discontinuous top layer). In some cases, the first pixels 852 include a first transparent cover layer and the second pixels 854 include a second transparent cover layer.

The first pixels 852 include a respective portion of the reflective layer 862, a first translucent layer 872, and a first partially reflective layer 863. The second pixels 854 include a respective portion of the reflective layer 862, a second translucent layer 874, and a second partially reflective layer 865. The first pixels 852 and the second pixels 854 may have similar properties and the pixel layers may be formed of similar materials as the first pixels 652 and the second pixels 654. The example of FIG. 8 is not limiting, and a top layer as described with respect to FIG. 8 may be used with other arrangements of pixels described herein.

FIG. 9 shows another example of a partial cross-sectional view of pixels of a colored marking. The array 950 of pixels includes a first set 952 of pixels having a first color and a second set 954 of pixels having a second color that is different from the first color. The view of FIG. 9 may be an example of a view along a section of an array similar to the array 450 of FIG. 4, except that in the array 950 adjacent pixels of the first set 952 contact each other and adjacent pixels of the second set 954 contact each other. A gap 982 is present between the first set 952 of pixels and the second set 954 of pixels.

As shown in FIG. 9, the pixels of the first set 952 adjoin each other and are contiguous at least in the plane of the cross-section and the pixels of the second set 954 adjoin each other and are contiguous at least in the plane of the cross-section. In addition, the translucent layer 972 and the partially reflective layer 963 are contiguous in the plane of the cross-section and the translucent layer 974 and the partially reflective layer 965 are contiguous in the plane of the cross-section. The housing component 922 may be similar to the housing component 122.

The pixels of the first set 952 include a respective portion of the reflective layer 962, a first translucent layer 972, and a first partially reflective layer 963. The pixels of the second set 954 include a respective portion of the reflective layer 962, a second translucent layer 974, and a second partially reflective layer 965. The reflective layer 962 may be similar in properties and materials to the reflective layer 562, the translucent layer 972 may be similar in properties and materials to the translucent layer 572, the translucent layer 974 may be similar in properties and materials to the translucent layer 574, the partially reflective layer 963 may be similar in properties and materials to the partially reflective layer 563 and the partially reflective layer 965 may be similar in properties and materials to the partially reflective layer 565.

In some cases, gaps may be present between pixels of a given set in other cross-sectional planes. For example, when the pixels have a generally circular outline in a top view, gaps may be present between pixels of a given set in other cross-sectional planes. In other cases, the pixels of a given set may have a shape, such as a generally rectangular shape, which allows the pixels of the set to fit together without gaps.

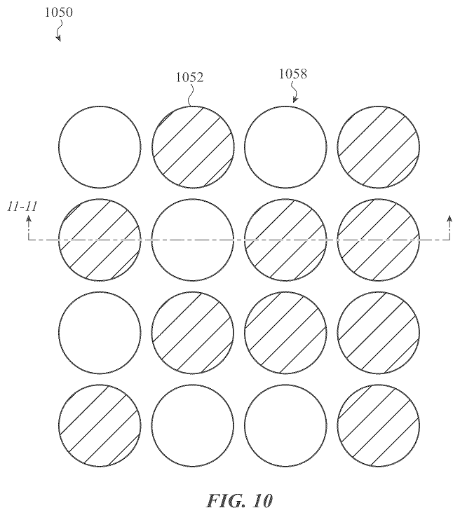

FIG. 10 shows another example of a top view of an array of pixels in a portion of a colored marking. The array 1050 of pixels includes first pixels 1052 having a chromatic color and second pixels 1058 having a substantially achromatic color (alternately referred to herein as achromatic pixels). The inclusion of achromatic pixels can be used to alter the spacing of pixels having a chromatic color and/or to produce a dithering pattern. In some examples, achromatic pixels may be distributed in the array to produce a gradient of a color, such as a gradient of the first color of the first pixels 1052. In some embodiments, the second pixels 1058 may have a high L* value (e.g., be substantially white) or have a low L* value (e.g., be substantially black).

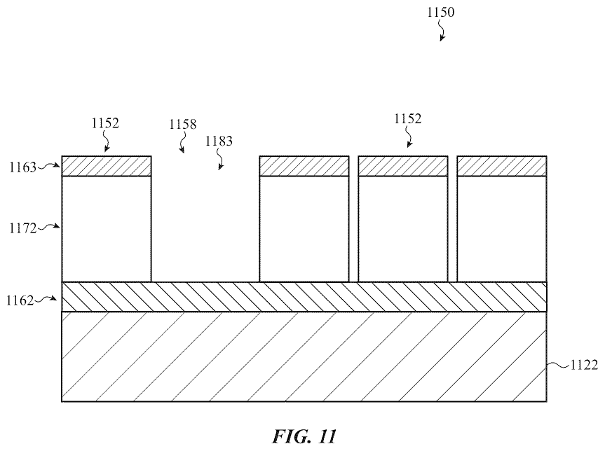

In some embodiments, achromatic pixels are produced by gaps between colored pixels that are large enough to produce a visual effect. For example, the gaps may have a lateral dimension that is greater than or equal to a lateral dimension of the colored pixels, such as shown in the example of FIG. 11. In these embodiments, the lightness value of the achromatic pixel may be influenced by the reflectivity of the material at the bottom of the gap. As examples, an achromatic pixel having a high L* value may be produced when the bottom of the gap is defined by a reflective layer or a reflective portion of the housing component. An achromatic pixel having a lower L* value may be produced when the bottom of the gap is defined by the housing component rather than a reflective layer, is defined by a light absorbing material provided over the housing component, and/or is defined by a roughened surface. In some cases, a housing component having a relatively high L* value may be laser-treated to produce a darker color at the bottom of the gap, such as a dark grey mark (e.g., prior to deposition of the colored pixels). In some cases, the housing component or a material provided over the housing component may be roughened using a laser-based process.

Achromatic pixels may also be produced by other pixel configurations. For example, an achromatic pixel may have a multilayer structure similar to that of the first pixels 1052 except that the translucent layer may be too thin or too thick to produce a chromatic color or may have a thickness that produces destructive interference. As another example, the partially reflective layer of the multilayer structure of an achromatic pixel may not effectively transmit light into an underlying translucent layer when this layer is too thick and/or includes a material with high light absorption. As another example, the achromatic pixel may include one or more layers of a material having a low L* value, such as a pigmented polymeric layer.

FIG. 11 shows another example of a partial cross-sectional view of pixels of a colored marking. The array 1150 of pixels includes a first set 1152 of pixels having a chromatic color and a second set 1158 of pixels having a substantially achromatic color. The view of FIG. 11 may be an example of a section of an array similar to the array 1050 of FIG. 10 along the line 11-11. The housing component 1122 may be similar to the housing component 122.

In the example of FIG. 11, each of the chromatic pixels 1152 includes a multilayer structure that may produce a color at least in part through interference. The reflective layer 1162, the translucent layer 1172, and the partially reflective layer 1163 may have similar properties and be formed of similar materials as previously discussed with respect to the reflective layer 562, the translucent layer 572, and the partially reflective layer 563.

In the example of FIG. 11, the achromatic pixels 1158 are produced by a gap 1183 between neighboring chromatic pixels 1152. Since the reflective layer 1162 defines the bottom of the gap 1183, the achromatic pixels 1158 may have a high L* value. If a lower L* value is desired, the reflective layer may be roughened or removed as previously described with respect to FIG. 10.

FIG. 12A shows another example of a top view of an array of pixels in a portion of a colored marking. In the example of FIG. 12A, the array 1250 includes pixels 1252, 1253, 1254, and 1255 that vary in diameter. In some examples, the pixels 1252, 1253, 1254, and 1255 may have the same color and the variation in the diameter may be used to produce a color gradient.

In the example of FIG. 12A, the diameter of the pixels increases from left to right. Specifically, the diameter D₁ is less than the diameter D₂, which is less than the diameter D₃, which is less than the diameter D₄. The spacing between the pixels is substantially the same as shown in FIG. 12A. However, this example is not limiting and in other examples the spacing between the pixels may be varied instead of the pixel diameter or both the pixel spacing and diameter may be varied.

In some embodiments, each of the pixels 1252, 1253, 1254, and 1255 has a same color. For example, the array 1250 may define a plurality of first pixels having a first color. The first pixels of the plurality of the first pixels may be arranged to define a gradient of the first color. In the example of FIGS. 12A and 12B, the first color would be paler at the left side of the plurality of pixels 1252, 1253, 1254, and 1255 and deeper at the right side. In some embodiments, the array of pixels may include two or more sets of pixels of different colors and variation in the size and/or spacing of the pixels of each color may be used to create a gradual transition from one color to another. As previously described, a laser-based technique may be used to produce pixels that vary in diameter and/or spacing.

FIG. 12B shows an example of a partial cross-sectional view of pixels from the colored marking of FIG. 12A. The array 1250 includes pixels 1252, 1253, 1254, and 1255 that vary in diameter, which can be used to produce a gradient effect as previously described with respect to FIG. 12A. The view of FIG. 12B may be an example of a view along the line 12B-12B of FIG. 12A. The housing component 1222 may be similar to the housing component 122.

In the example of FIG. 12B, each of the pixels 1252, 1253, 1254, and 1255 includes a multilayer structure that can produce a color at least in part through interference. The pixel 1252 includes the reflective layer 1262, the translucent layer 1272, and the partially reflective layer 1263. The pixel 1253 includes the reflective layer 1262, the translucent layer 1273, and the partially reflective layer 1264. The pixel 1254 includes the reflective layer 1262, the translucent layer 1274, and the partially reflective layer 1265. The pixel 1255 includes the reflective layer 1262, the translucent layer 1275, and the partially reflective layer 1255. In embodiments where the pixels are configured to produce substantially the same color, the translucent layers 1272, 1273, 1274, and 1275 may have substantially the same thickness and composition and the partially reflective layers 1263, 1264, 1265, and 1266 may have substantially the same thickness and composition. The reflective layer 1262 may be similar in properties and materials to the reflective layer 562, the translucent layers 1272, 1273, 1274, and 1275 may be similar in properties and materials to the translucent layer 572, and the partially reflective layers 1263, 1264, 1265, and 1266 may be similar in properties and materials to the partially reflective layer 563.

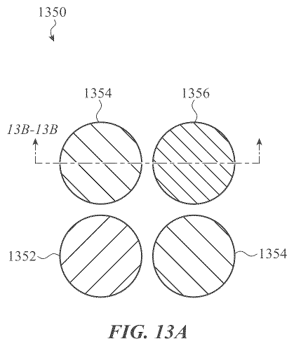

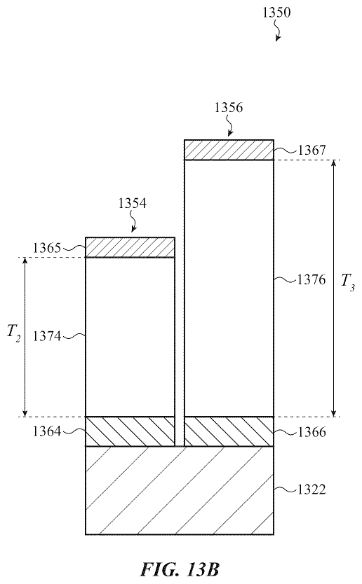

FIG. 13A shows an example of a top view of a set of subpixels in a portion of a colored marking. The set of subpixels may define a pixel and the color of the pixel (alternately, the pixel color) is determined by the subpixels in the set. In the example of FIG. 13A, the set 1350 of subpixels includes four subpixels. However, this example is not limiting and in other examples a set of subpixels may include a different number of subpixels, including, but not limited to, three subpixels.

In the example of FIG. 13A, the set 1350 of subpixels includes subpixels having three different colors: a subpixel 1352 that has a first color, two subpixels 1354 that have a second color, and a subpixel 1356 that has a third color. The example of FIG. 13A is not limiting and in other examples a set of subpixel(s) may include only a single color of subpixel(s), only two colors of subpixels, or more than three colors of subpixels. In some cases, the set of subpixels may include an achromatic color as well as a chromatic color.

The set 1350 of subpixels defines a subpixel layout. In some embodiments, the subpixel layout includes subpixels having a blue color, subpixels having a green color, and subpixels having a red color. In other embodiments, the subpixel layout includes subpixels having a cyan color, subpixels having a magenta color, and subpixels having a yellow color. The subpixels may have lateral dimensions small enough that a viewer perceives the combined effect of the subpixels rather than the individual subpixels. For example, the subpixels may have a diameter from 2 micrometers to less than 15 micrometers or from 2 micrometers to less than 10 micrometers. The subpixel layout shown in FIG. 13A is exemplary rather than limiting and any suitable subpixel layout may be used, including layouts that include achromatic subpixels.

FIG. 13B shows an example of a partial cross-sectional view of subpixels of FIG. 13A taken along line 13B-13B in FIG. 13A. The set 1350 of subpixels shown in FIG. 13B includes subpixels 1354 and subpixels 1356 that have different colors. The view of FIG. 13B may be an example of a view along the line 13B-13B of FIG. 13A. The housing component 1322 may be similar to the housing component 122.

The difference in the color of the subpixels 1354 and 1356 may be due at least in part to differences in the translucent layer thickness. In the example of FIG. 13B, the translucent layer 1374 of the subpixel 1354 has a thickness T₂ and the translucent layer 1376 of the subpixel 1376 has a thickness T₃. As previously described with respect to FIG. 13A, the subpixel layout may include subpixels having three different colors. Therefore, the subpixel layout may also include a subpixel that has a color different than the colors of the subpixels 1354 and 1356, and a translucent layer thickness different than T₂ and T₃ (e.g., T₁).

At least some of the subpixels of the set 1350 may have a color due at least in part to optical interference. The color of these subpixels may be due to their multilayer structure, which may be similar to that of the pixels previously presented with respect to the examples of FIGS. 5-9 or any other pixels described herein. The subpixels 1354 include a reflective layer 1364, a translucent layer 1374, and a partially reflective layer 1365. The subpixels 1356 include a reflective layer 1366, a second translucent layer 1376, and a second partially reflective layer 1367. The reflective layers 1364 and 1366 may be similar in properties and materials to the reflective layer 562 and 564, the translucent layers 1374 and 1376 may be similar in properties and materials to the translucent layers 572 and 574, and the partially reflective layers 1365 and 1367 may be similar in properties and materials to the partially reflective layers 563 and 565.

FIG. 14 shows another example of a partial cross-sectional view of pixels of a colored marking. The array 1450 of pixels includes first pixels 1452 having a first color and second pixels 1454 having a second color that is different from the first color. The hatching patterns shown in FIG. 14 are not intended to limit the pixels to specific colors. Instead, the different hatching patterns are intended to clearly illustrate differences between the pixel colors. The view of FIG. 14 may be an example of a view along line 5-5 of the array 450 of FIG. 4. The array 1450 of pixels is formed on a housing component 1422, which may be similar to the housing component 122.

In the example of FIG. 14, each of the first pixels 1452 and the second pixels 1454 include a color-producing feature. The first pixel 1452 includes the color-producing feature 1472 and the second pixel 1454 includes the color-producing feature 1474. In some embodiments, at least one pixel of the array 1450 may include a color-producing feature other than the multilayer structures previously described that produce a color at least in part through optical interference. In some cases, all the pixels of the array may include a color-producing feature other than a multilayer structure that produces a color at least in part through optical interference. In other cases, the array may include pixels that produce a color at least in part through optical interference and pixels that produce a color by a mechanism other than optical interference. The color-producing feature may produce a chromatic color or an achromatic color.

Examples of color-producing features other than multilayer structures configured to produce optical interference include, but are not limited to, a polymeric film, a metallic film, a metal oxide film, and the like. In some cases, the color-producing feature may have the form of a single layer. In other cases, the color-producing features may include multiple layers, either as multiple layers of the same type of color-producing feature (e.g., multiple pigmented polymeric film layers) or combinations of different types of color-producing features. If the layer(s) are deposited through a laser-based technique, the layer(s) may be thinner than layers that would be produced with conventional techniques. Therefore, the layer(s) may have a reduced tactile presence as compared to film layer(s) of similar composition that are deposited via a conventional technique. In some cases, the color-producing feature may be part of a multi-layer structure that includes a layer such as a transparent or partially transmissive layer over the color-producing feature and/or a layer that provides adhesion, substrate color-blocking and/or reflectivity below the color-producing feature.

In some embodiments, a polymeric film color producing feature may include a coloring agent such as a pigment or dye in a matrix or binder of a polymer material. Such a polymeric film may produce a color at least in part through absorption of some wavelengths of light. Reflection of other wavelengths of light may also contribute to the perceived color of the color producing feature. In some cases, the polymeric film color producing feature may allow transmission of some light through the polymeric film. In these cases, the perceived color of the polymeric film color producing feature may be affected by a housing member positioned below the polymeric film color producing feature. For example, when a reflective housing member such as a housing member formed from a metal is positioned below the polymeric film, light may be reflected back through the polymer film, so that transmission of light through the polymeric film also contributes to the perceived color of the color producing feature. When the reflection of light from the reflective housing member is wavelength dependent, this may further influence the perceived color of the color producing feature. As previously discussed, a polymeric film color producing feature may be formed from a single layer or may be formed from multiple layers. Each of the multiple layers may be the same, or some of the layers may differ in thickness and/or composition.

In some embodiments, a metallic film color producing feature may produce a color at least in part through reflection and/or absorption of light. For example, wavelength dependent reflection from the metallic film color producing feature may affect the perceived color of the metallic film color producing feature. In some cases, the perceived color of the metallic film color producing feature may be affected by its thickness. In these cases, different perceived colors may be produced by metallic film color producing features having different thicknesses. In some examples, the metallic film color producing feature may be thin enough to be transmissive to at least some wavelengths of visible light. As previously discussed, a metallic film color producing feature may be formed from a single layer or may be formed from multiple layers. Each of multiple layers may have a same composition or at least two of the layers may differ in composition.

Furthermore, the metallic film color producing feature may be combined with one or more other layers. As an example, a multilayer structure may include a metallic film color producing feature and a metal oxide film color producing feature, where the color is created by absorbing and/or reflecting light interacting with the multilayer structure. In some cases, a metallic film color producing feature may be positioned below the metal oxide film color producing feature. Alternately or additionally, a metallic film color producing feature may be positioned above the metal oxide film color producing feature when the metallic film color producing feature is thin enough to be transmissive to visible light. As an additional example, the multilayer structure may include a metallic film color producing feature and a polymeric film color producing feature. In some cases, a light transmissive polymeric film color producing feature may be positioned above a metallic film color producing feature and/or a light transmissive metallic film color producing feature may be positioned above a polymeric film color producing feature.

In some embodiments, a metal oxide film color producing feature may produce a color at least in part through reflection and/or absorption of light. For example, wavelength dependent reflection from the metal oxide film color producing feature may affect the perceived color of the metal oxide film color producing feature. In some cases, the perceived color of the metal oxide color producing feature may be affected by its thickness. In these cases, different perceived colors may be produced by metal oxide film color producing features having different thicknesses. As previously discussed, a metal oxide film color producing feature may be formed from a single layer or may be formed from multiple layers. Each of the multiple layers may have a same composition or at least two of the layers may differ in composition. Furthermore, the metal oxide color producing feature may be combined with one or more other layers, such as a polymeric film color producing feature and/or a metallic film color producing feature to form a multilayer structure that has a perceived color that is affected by the combination of color producing features.

The different colors of the first and second pixels 1452 and 1454 may be produced in a variety of ways. In some embodiments, each of the first pixels 1452 comprises a first laser-deposited layer formed from a first material and contributing to the first color and each of the second pixels 1454 comprises a second laser-deposited layer formed from the second material and contributing to the second color, the second material different from the first material. In some examples, each of the first material and the second material is a polymeric material. In other examples, each of the first material and the second material is a metallic material or a metal oxide material. In other examples, the first material and the second material are different classes of materials (e.g., the first material is a polymeric material and the second material is a metallic material or a metal oxide material). Alternately or additionally, the different colors may be produced at least in part by different thicknesses of the laser-deposited layer. For example, each of the first pixels 1452 may comprise a first laser-deposited layer having a first thickness and each of the second pixels 1454 may comprise a second laser-deposited layer having a second thickness greater than the first thickness.

In the example of FIG. 14, the first and second pixels 1452 and 1454 are deposited on the surface 1430 of the housing component 1422, which may be similar to the housing component 122. For convenience of illustration, the first pixels 1452 and the second pixels 1454 are shown has having substantially the same thickness and diameter. However, the example of FIG. 14 is not intended to be limiting and in other examples, different pixels may differ in diameter and/or height as previously described. The array 1450 defines a gap 1482 between neighboring first and second pixels 1452 and 1454, as well as a gap 1483 between neighboring first pixels 1452 and a gap 1484 between neighboring second pixels 1454. However, in other examples, neighboring pixels may adjoin one another as previously shown with respect to FIG. 9.

FIGS. 15A, 15B, and 15C show another example of an electronic device including a colored marking. For example, the electronic device 1500 may be a computing device, such as a tablet computing device.

In the example of FIGS. 15A, 15B, and 15C, the electronic device 1500 includes an enclosure 1510 that includes a housing component 1522 and a cover 1521. As shown in FIG. 15B, a colored marking 1540 is formed on a rear surface 1504 of the housing component 1522. The colored marking 1540 may be any of the colored markings described with respect to FIGS. 1 through 14. The example of FIG. 15B is not limiting and in additional examples the colored marking 1540 may be formed on any suitable surface of the enclosure 1510.

The electronic device 1500 includes a display 1542 and a cover 1521 positioned over the display 1542. In some cases, the display 1542 may be a touch screen display that includes both a display and a touch sensor. The display 1542 may be any of the displays described with respect to FIG. 16.

The cover 1521 at least partially defines the front surface 1502 of the electronic device and in some embodiments may define a substantial portion of the front surface 1502. The cover 1521 may alternately be referred to as a front cover herein. The cover 1521 defines a transparent portion through which graphical output from the display may be viewed. The cover 1521 may include a cover member 1533, which in some cases may be a transparent member. The cover member 1533 may be formed from a glass material, a glass ceramic material, a polymer material, or combinations thereof. For example, the cover member 1533 may include layers of glass and/or glass ceramic material bound together with a polymer material. In some cases, the cover member 1533 is formed of an ion-exchangeable material that is ion-exchanged to form a compressive stress layer along one or more surfaces of the cover member 1533. The cover member 1533 may extend laterally across the cover 1521, such as substantially across the width and the length of the cover 1521. In some examples, the cover member 1533 may have a thickness greater than 0.3 mm and less than 2 mm. In some instances, the cover 1521 may include a coating along a portion of an interior surface of the cover member 1533 in order to mask or obscure interior components of the electronic device from view and/or to provide a decorative effect.

The housing component 1522 defines at least a portion of the rear surface 1504 and the side surface 1506 of the electronic device 1500. In some embodiments, the housing component 1522 also defines a portion of the front surface 1502 of the electronic device 1500. In some examples, the housing component 1522 is formed of a polymer material, a metal material, a glass material, a glass ceramic material, a ceramic material, or a combination thereof. In some embodiments when the colored marking 1540 is formed at the surface of a metal portion of the housing component, the metal portion of the housing component may act as the reflective layer of the multilayer structure of one or more pixels. The example of FIGS. 15A-15C is not limiting and in other examples the enclosure may include a rear cover.

The electronic device 1500 also includes a rear facing camera 1582, as shown in FIG. 15B. In some embodiments, the electronic device 1500 also includes a front facing camera, which may be positioned along a side of the display 1542 or under the display 1542. The electronic device 1500 also includes additional device components positioned within an internal cavity 1501 defined by the enclosure 1510. As shown in FIG. 15C, these device components include, but are not limited to, a battery 1584 and circuitry 1586. The circuitry 1586 may be operably coupled to the battery. The circuitry 1586 may include electronic circuitry that comprises a processor. Alternately or additionally, the circuitry 1586 may include wireless communication circuitry. The example of FIGS. 15A-15C is not intended to be limiting and more generally the electronic device may include any of the components described with respect to FIG. 16.

FIG. 16 shows a block diagram of components of an electronic device. The electronic device 1600 can incorporate an enclosure having a colored marking as described herein. The schematic representation of FIG. 16 may correspond to components of the devices depicted in FIGS. 1 and 15A-15C as described above. However, FIG. 16 may also more generally represent other types of electronic devices including an enclosure having a colored marking as described herein.

In embodiments, an electronic device 1600 may include a display 1602. The display 1602 may include a liquid-crystal display (LCD), a light-emitting diode (LED) display, an LED-backlit LCD display, an organic light-emitting diode (OLED) display, an active-matrix organic light-emitting diode (AMOLED) display, an organic electroluminescent (EL) display, an electrophoretic ink display, or the like. If the display 1602 is a liquid-crystal display or an electrophoretic ink display, the display 1602 may also include a backlight component that can be controlled to provide variable levels of display brightness. If the display 1602 is an organic light-emitting diode or an organic electroluminescent-type display, the brightness of the display 1602 may be controlled by modifying the electrical signals that are provided to display elements. In addition, information regarding configuration and/or orientation of the electronic device may be used to control the output of the display as described with respect to input devices 1612. In some cases, the display is integrated with a touch and/or force sensor in order to detect touches and/or forces applied along an exterior surface of the device 1600.

The device 1600 also includes a processor 1604. The processor 1604 may be operably connected with a computer-readable memory 1608. The processor 1604 may be operatively connected to the memory 1608 component via an electronic bus or bridge. The processor 1604 may be implemented as one or more computer processors or microcontrollers configured to perform operations in response to computer-readable instructions. The processor 1604 may include a central processing unit (CPU) of the device 1600. Additionally, and/or alternatively, the processor 1604 may include other electronic circuitry within the device 1600 including application specific integrated chips (ASIC) and other microcontroller devices. The processor 1604 may be configured to perform functionality described in the examples above.

The device 1600 also includes a power source 1606. In some embodiments, the power source includes a battery that is configured to provide electrical power to the components of the electronic device 1600. The battery may include one or more power storage cells that are linked together to provide an internal supply of electrical power. The battery may be operatively coupled to power management circuitry that is configured to provide appropriate voltage and power levels for individual components or groups of components within the electronic device 1600. The battery, via power management circuitry, may be configured to receive power from an external source, such as an alternating current power outlet. The battery may store received power so that the electronic device 1600 may operate without connection to an external power source for an extended period of time, which may range from several hours to several days.

The memory 1608 may include a variety of types of non-transitory computer-readable storage media, including, for example, read access memory (RAM), read-only memory (ROM), erasable programmable memory (e.g., EPROM and EEPROM), or flash memory. The memory 1608 is configured to store computer-readable instructions, sensor values, and other persistent software elements.

The device 1600 also includes a sensor system 1610. The sensor system 1610 may include one or more sensors or sensor components, such as a force sensor, a capacitive sensor, an accelerometer, a barometer, a gyroscope, a proximity sensor, a light sensor, a microphone, an acoustic sensor, a light sensor (including ambient light, infrared (IR) light, ultraviolet (UV) light), an optical facial recognition sensor, a depth measuring sensor (e.g., a time of flight sensor), a health monitoring sensor (e.g., an electrocardiogram (erg) sensor, a heart rate sensor, a photoplethysmogram (ppg) sensor, a pulse oximeter, a biometric sensor (e.g., a fingerprint sensor), or other types of sensing devices. In some cases, the device 1600 includes a sensor array (also referred to as a sensing array) which includes multiple sensors. For example, a sensor array may include an ambient light sensor, a Lidar sensor, and a microphone. In additional examples, one or more camera components may also be associated with the sensor array. The sensor system 1610 may be operably coupled to processing circuitry. In some embodiments, the sensors may detect deformation and/or changes in configuration of the electronic device and be operably coupled to processing circuitry that controls the display based on the sensor signals. In some implementations, output from the sensors system is used to reconfigure the display output to correspond to an orientation or folded/unfolded configuration or state of the device. Example sensors for this purpose include accelerometers, gyroscopes, magnetometers, and other similar types of position/orientation sensing devices.

The input/output mechanism 1612 may include one or more input devices and one or more output devices. The input device(s) are devices that are configured to receive input from a user or the environment. An input device may include, for example, a push button, a touch-activated button, a capacitive touch sensor, a touch screen (e.g., a touch-sensitive display or a force-sensitive display), a capacitive touch button, dial, crown, or the like. In some embodiments, an input device may provide a dedicated or primary function, including, for example, a power button, volume buttons, home buttons, scroll wheels, and camera buttons. The one or more output devices include the display 1602 that renders visual information, which may be generated by the processor 1604. The one or more output devices may also include one or more speakers to provide audio output and/or one or more haptic devices that are configured to produce a haptic or tactile output along an exterior surface of the device 1600. The input/output mechanism may also include a communication port or a communication channel. A communication channel may include one or more wireless interface(s) that are adapted to provide communication between the processor 1604 and an external device, one or more antennas (e.g., antennas that include or use housing components as radiating members), communications circuitry, firmware, software, or any other components or systems that facilitate wireless communications with other devices.

The electronic device 1600 also includes a system bus 1614 in communication with the elements 1602, 1604, 1606, 1608, 1610, and 1612. In some examples, the system bus 1614 includes circuitry, such as electronic buses and/or bridges. The system bus 1614 may also include application specific integrated chips (ASIC) and other microcontroller devices.

As used herein, the terms “about,” “approximately,” “substantially,” “similar,” and the like are used to account for relatively small variations, such as a variation of +/−10%, +/−5%, +/−2%, or +/−1%. In addition, use of the term “about” in reference to the endpoint of a range may signify a variation of +/−10%, +/−5%, +/−2%, or +/−1% of the endpoint value. In addition, disclosure of a range in which at least one endpoint is described as being “about” a specified value includes disclosure of the range in which the endpoint is equal to the specified value. Furthermore, referring to a layer of a multilayer structure as “below” another layer indicates that the layer is closer to the surface of the housing member than the other layer.

The following discussion applies to the electronic devices described herein to the extent that these devices may be used to obtain personally identifiable information data. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

What is claimed is:

1. An electronic device comprising:
a battery;
electronic circuitry operably coupled to the battery and comprising a processor;
wireless communication circuitry operably coupled to the battery; and
an enclosure enclosing the battery, the electronic circuitry, and the wireless communication circuitry, the enclosure comprising:
a housing member defining an exterior surface of the electronic device; and
an image formed at the exterior surface and comprising a plurality of pixels, the plurality of pixels including:
a first pixel configured to produce a first color, the first pixel comprising:
a first interference layer formed from a metal oxide, disposed over the exterior surface, and having a first thickness; and
a first cover layer formed from a metal, disposed over the first interference layer, and configured to partially reflect visible light; and
a second pixel configured to produce a second color different from the first color, the second pixel comprising:
a second interference layer formed from the metal oxide, disposed over the exterior surface, and having a second thickness different from the first thickness; and
a second cover layer formed from the metal, disposed over the second interference layer, and configured to partially reflect visible light.

2. The electronic device of claim 1, wherein a difference between the first color and the second color is due at least in part to a difference between the first thickness and the second thickness.

3. The electronic device of claim 2, wherein:
the first pixel and the second pixel are adjacent to each other in the image; and
the plurality of pixels defines a gap between:
the first interference layer and the second interference layer; and
the first cover layer and the second cover layer.

4. The electronic device of claim 2, wherein:
the housing member is formed from a polymer material;
the image is formed at a marking region of the exterior surface;
a frame region of the exterior surface surrounds the image; and
the marking region is recessed with respect to the frame region.

5. The electronic device of claim 4, wherein pixels of the plurality of pixels are recessed with respect to the frame region of the exterior surface.

6. The electronic device of claim 1, wherein:
the metal is a second metal;
the first pixel further comprises a first base layer formed from a first metal and disposed between the exterior surface and the first interference layer; and
the second pixel further comprises a second base layer formed from the first metal and disposed between the exterior surface and the second interference layer.

7. The electronic device of claim 6, wherein the first metal and the second metal are a same metal.

8. An electronic device comprising:
an enclosure comprising:
a housing member defining an exterior surface of the electronic device; and
a multicolored marking disposed over a surface of the housing member and comprising an array of pixels, the array of pixels including:
a plurality of first pixels, each of the first pixels having a first color and comprising a first laser-deposited layer that contributes to the first color; and
a plurality of second pixels, each of the second pixels having a second color, different from the first color; and comprising a second laser-deposited layer, different from the first laser-deposited layer, that contributes to the second color; and
a battery positioned within the enclosure.

9. The electronic device of claim 8, wherein:
each of the first pixels includes a first multilayer structure that comprises the first laser-deposited layer; and
each of the second pixels comprises a second multilayer structure that comprises the second laser-deposited layer.

10. The electronic device of claim 9, wherein:
the first multilayer structure further comprises a first transparent cover layer disposed over the first laser-deposited layer; and
the second multilayer structure further comprises a second transparent cover layer disposed over the second laser-deposited layer.

11. The electronic device of claim 9, wherein:
the first multilayer structure comprises:
a first reflective layer disposed over a first portion of the surface of the housing member;
the first laser-deposited layer disposed over the first reflective layer and formed from a first translucent material; and
a first partially reflective layer disposed over the first laser-deposited layer; and
the second multilayer structure comprises:
a second reflective layer disposed over a second portion of the surface of the housing member;
the second laser-deposited layer disposed over the second reflective layer and formed from a second translucent material; and
a second partially reflective layer disposed over the second laser-deposited layer.

12. The electronic device of claim 11, wherein:
each of the first reflective layer and the second reflective layer is formed from a first metal;
each of the first partially reflective layer and the second partially reflective layer is formed from a second metal;
each of the first translucent material and the second translucent material is an inorganic dielectric material;
the first multilayer structure produces the first color at least in part through a first optical interference; and
the second multilayer structure produces the second color at least in part through a second optical interference.

13. The electronic device of claim 8, wherein:
the first laser-deposited layer is formed from a first material; and
the second laser-deposited layer is formed from a second material, different from the first material.

14. The electronic device of claim 8, wherein:
the first laser-deposited layer has a first thickness; and
the second laser-deposited layer has a second thickness greater than the first thickness.

15. An electronic device comprising:
an enclosure comprising:
a housing member defining an exterior surface of the electronic device; and
an image formed at a region of the exterior surface and comprising:
a first subpixel having a first color due to a first optical interference, the first subpixel comprising:
a first reflective base layer disposed over the region of the exterior surface;
a first translucent layer disposed over the first reflective base layer; and
a first partially reflective cover layer disposed over the first translucent layer; and
a second subpixel having a second color, different from the first color, due to a second optical interference, the second subpixel comprising:
a second reflective base layer disposed over the region of the exterior surface;
a second translucent layer disposed over the second reflective base layer; and
a second partially reflective cover layer disposed over the second translucent layer;
a battery positioned within the enclosure; and
electronic circuitry positioned within the enclosure and coupled to the battery.

16. The electronic device of claim 15, wherein:
the first reflective base layer and the second reflective base layer are contiguous;
the first translucent layer has a first thickness that contributes to the first optical interference; and
the second translucent layer has a second thickness that contributes to the second optical interference, the second thickness different from the first thickness.

17. The electronic device of claim 16, wherein:
the first subpixel and the second subpixel together define a set of subpixels; and
each of the first subpixel and the second subpixel has a diameter less than 15 micrometers.

18. The electronic device of claim 17, wherein:
the set of subpixels is a first set of subpixels that defines a first pixel having a first pixel color; and
the image further comprises a second set of subpixels, different than the first set of subpixels, and the second set of subpixels defines a second pixel having a second pixel color that is different from the first pixel color.

19. The electronic device of claim 15, wherein:
the region of the exterior surface is a first region that has a first texture; and
a second region of the exterior surface that surrounds the first region has a second texture that is different from the first texture.

20. The electronic device of claim 19, wherein:
the housing member is formed of a polymer material and defines a recess; and
the first region of the exterior surface defines a bottom of the recess.
